(19) United States
(12) Patent Application Publication
(10) Pub. No.: US 2012/0145842 A1
(43) Pub. Date: Jun. 14, 2012

(54) Pen and pencil holder

(76) Inventor: Marvin Gregory Ripke, Veneta, OR (US)

(21) Appl. No.: 13/200,055

(22) Filed: Sep. 19, 2011

(51) Int. Cl. F16M 11/22

(52) U.S. Cl. 248/158

(57) ABSTRACT

The invention is a thin strip of material to which pens and pencils are affixed by the clip attached to pens and pencils. The invention holds the pens and pencils for easy storage and easy access. The art is new in that other pen and pencil holders rely on a container, either a cup, slot or tube.

### BACKGROUND OF THE INVENTION

Pens and pencils and like articles are usually kept in a container or in a pocket when they are not being used. Applicant's invention is intended to overcome the lack of orderliness of prior applications by making storage easy and allowing display of pens and pencils for easy selection of particular pens and pencils.

### BRIEF SUMMARY OF THE INVENTION

A thin strip of material, preferably plastic, to which pens and pencils may be attached by the clip. The invention is the use of thin strip of material in conjunction with a clip attached to pens and pencils. The strip is secured in a manner that pens and pencils will, when attached by use of the pen or pencil clip, hang from the strip.

Most applications rely on a cup where a jumble of pens and pencils reside, visible only by the top thereof, making it difficult to tell whether the selection desired is a pen or pencil.

### BRIEF DESCRIPTION OF THE DRAWINGS

FIG. 1 shows a pedestal in a horizontal position. A pole is set into the pedestal and rises vertically. A slot in the top of the pole allows placement, horizontally across the pole and parallel to the pedestal, a thin strip of material. The drawing illustrates the desired attaching of a pen or pencil to the this strip.

FIG. 2 is a side view.

FIG. 3 is a top view.

FIG. 4 shows a pedestal in a horizontal position. Two poles are set into the pedestal and rise vertically. A slot in the top of each pole allows placement across the two poles and parallel to the pedestal of a thin strip of material. The drawing illustrates the desired attaching of a pen or pencil to the this strip.

### DETAILED DESCRIPTION OF THE INVENTION

The invention is a method of affixing pens and pencils by their clip to a thin strip of material, either plastic or metal. A pedestal has two poles, or one, inserted in a manner that they rise vertically from the pedestal. The strip is affixed to the poles, or pole, so it runs parallel to the pedestal, allowing pens and pencils to be attached by their clip, thereby hanging freely for transparent display and ease of selection for use.

I made the prototype by purchasing a shallow wooden dish. I drilled two quarter inch holes in the base of the dish and at each side of the dish. I cut a ¼″ dowel to a height of about 8″ and, using a hacksaw, cut slots in the ends of the dowels to a depth of about 1″ after which I set the uncut ends into the holes drilled in the dish. I then secured a thin plastic strip, a bookmark, into the slots, secured the strip with a dab of glue, all of which took no more than five minutes.

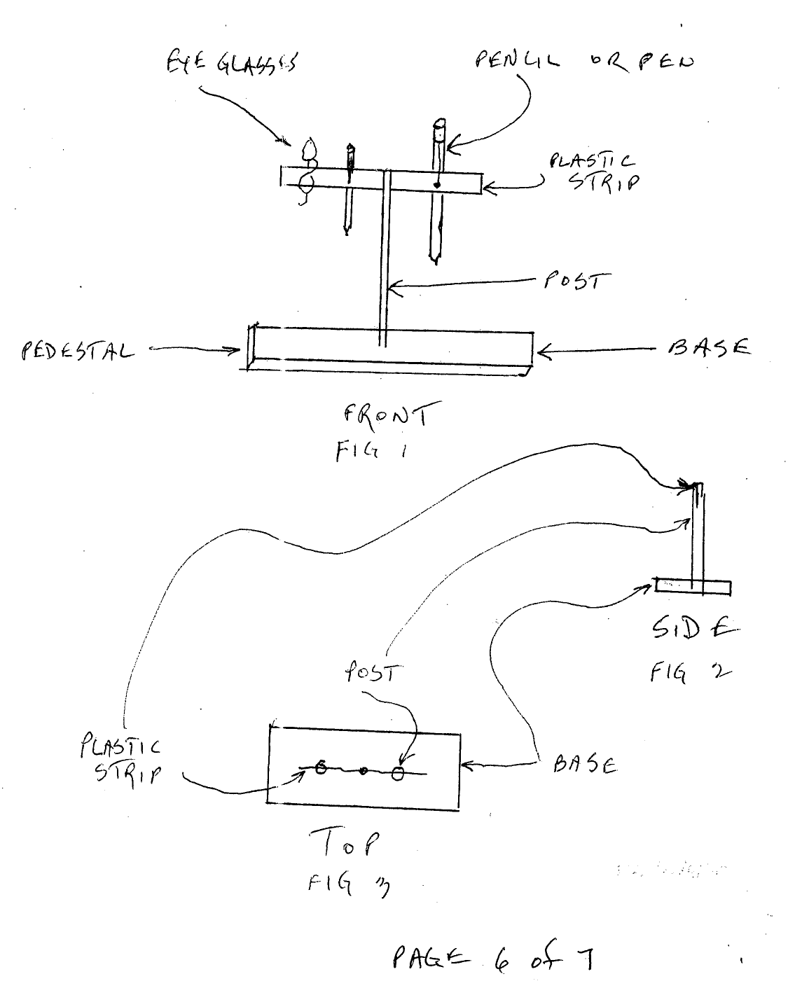

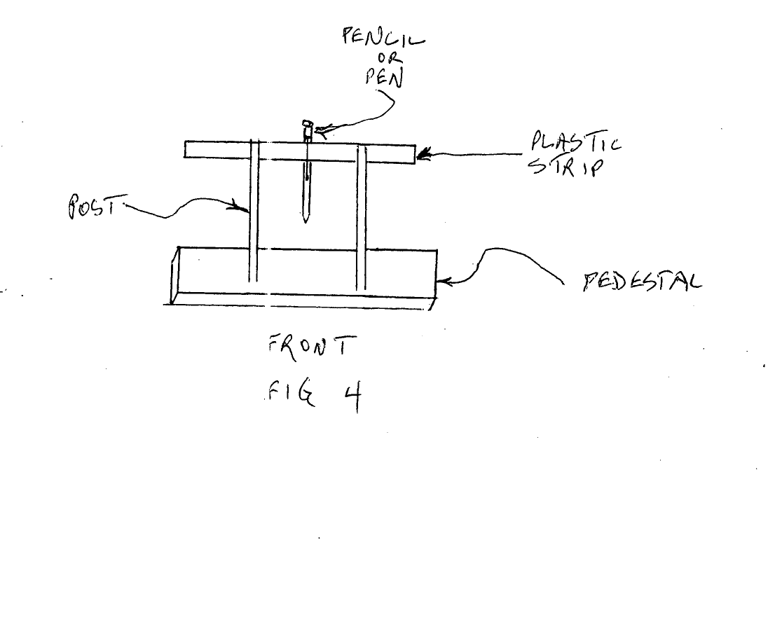

The invention takes advantage of the prior application of the clip attached to pens and pencils. The invention holds pens and pencils for the same purpose as the clip. The invention is distinguished by the method of holding pens and pencils. Prior applications focus on storage in a container whereas applicant's invention focuses on the same principle for which the clip was designed, namely to attach a pen or pencil to a shirt pocket. The applicant's invention expands the principle by allowing for storage in a manner that displays the pen or pencil on a desktop and further allows for storage of a large number of pens and pencils at one place. FIG. 1. The invention is not the clip but the use of the clip.

1. The invention claims a thin strip of material, preferably plastic, affixed to posts that are in turn inserted into a base, with the posts perpendicular to the base and the thin strip parallel to the base, thereby allowing pens and pencils to be attached to the thin strip of material by the pen or pencil clip, thereby allowing easy access to a easily chosen pen or pencil.
